(19) United States
(12) Patent Application Publication
(10) Pub. No.: US 2020/0090042 A1
(43) Pub. Date: Mar. 19, 2020

(54) DATA EFFICIENT IMITATION OF DIVERSE BEHAVIORS

(71) Applicant: DeepMind Technologies Limited, London (GB)

(72) Inventors: Gregory Duncan Wayne, London (GB); Joshua Merel, London (GB); Ziyu Wang, St. Albans (GB); Nicolas Manfred Otto Heess, London (GB); Joao Ferdinando Gomes de Freitas, London (GB); Scott Ellison Reed, New York, NY (US)

(21) Appl. No.: 16/688,934

(22) Filed: Nov. 19, 2019

Related U.S. Application Data
(63) Continuation of application No. PCT/EP2018/063281, filed on May 22, 2018.
(60) Provisional application No. 62/508,972, filed on May 19, 2017.

(51) Int. Cl. G06N 3/08; G06N 3/04

(52) U.S. Cl. CPC G06N 3/08; G06N 3/0445; G06N 3/0454

(57) ABSTRACT

Methods, systems, and apparatus, including computer programs encoded on computer storage media, for training a neural network used to select actions to be performed by an agent interacting with an environment. One of the methods includes: obtaining data identifying a set of trajectories, each trajectory comprising a set of observations characterizing a set of states of the environment and corresponding actions performed by another agent in response to the states; obtaining data identifying an encoder that maps the observations onto embeddings for use in determining a set of imitation trajectories; determining, for each trajectory, a corresponding embedding by applying the encoder to the trajectory; determining a set of imitation trajectories by applying a policy defined by the neural network to the embedding for each trajectory; and adjusting parameters of the neural network based on the set of trajectories, the set of imitation trajectories and the embeddings.

### CROSS REFERENCE TO RELATED APPLICATIONS

This application is a continuation of and claims priority to PCT Application No. PCT/EP2018/063281, filed on May 22, 2018, which claims priority to U.S. Provisional Application No. 62/508,972, filed on May 19, 2017. The disclosures of the prior applications are considered part of and are incorporated by reference in the disclosure of this application.

### BACKGROUND

This specification relates to methods and systems for training a neural network.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step. An example of a recurrent neural network is a long short term (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

This specification describes how a system implemented as computer programs on one or more computers in one or more locations can adjust the parameters of a neural network used to select actions to be performed by an agent interacting with an environment in response to received observations. This is generally referred to as “training” a neural network.

Implementations described herein utilize a combination of variational auto encoding and reinforcement learning to train the system to imitate the behavior of a training set of trajectories.

In a reinforcement learning system data may be output for selecting actions to perform, under control of the system. In order for the agent to interact with the environment, the system receives data characterizing the current state xₜ of the environment ε at time t and selects an action aₜ to be performed by the agent in response to the received data according to its policy π. A policy π is a mapping from states to actions. In return, the agent receives a scalar reward rₜ. The return Rₜ=Σₖ₌₀^{∞}γ^{k}^{ᵣ}t+k is the total accumulated reward from time step t with discount factor γ^{k}ϵ(0,1]. The goal of the agent is to maximize the expected return from each state. Data characterizing a state of the environment will be referred to in this specification as an observation.

In some implementations, the environment is a simulated environment and the agent is implemented as one or more computer programs interacting with the simulated environment. For example, the simulated environment may be a video game and the agent may be a simulated user playing the video game. As another example, the simulated environment may be a motion simulation environment, e.g., a driving simulation or a flight simulation, and the agent is a simulated vehicle navigating through the motion simulation. In these implementations, the actions may be control inputs to control the simulated user or simulated vehicle. In another example the simulated environment may be the environment of a robot and the agent may be a simulated robot. The simulated robot may then be trained to perform a task in the simulated environment and the training transferred to a system controlling a real robot.

In some other implementations, the environment is a real-world environment and the agent is a mechanical agent interacting with the real-world environment. For example, the agent may be a robot interacting with the environment to accomplish a specific task. As another example, the agent may be an autonomous or semi-autonomous vehicle navigating through the environment. In these implementations, the actions may control inputs to control the robot or the autonomous vehicle.

In general, one innovative aspect of the subject matter described in this specification can be embodied in a method for training a neural network used to select actions to be performed by an agent interacting with an environment. The method comprises obtaining data identifying a set of trajectories, each trajectory comprising a set of observations characterizing a set of states of the environment and corresponding actions performed by another agent in response to the states and obtaining data identifying an encoder that maps the observations onto embeddings for use in determining a set of imitation trajectories. The method further comprises determining, for each trajectory, a corresponding embedding by applying the encoder to the trajectory, determining a set of imitation trajectories by applying a policy defined by the neural network to the embedding for each trajectory, and adjusting parameters of the neural network based on the set of trajectories, the set of imitation trajectories and the embeddings.

The set of imitation trajectories may be trajectories comprising state action pairs that aim to copy the set of (training) trajectories. Each embedding can comprise a set of latent variables that can be decoded to determine a set of imitation trajectories. Once the parameters for the neural network have been adjusted (once the neural network has been trained) the neural network can imitate behavior that is observed in the set of (training) trajectories.

By adjusting the parameters of the neural network based on embeddings (latent variables) determined via an encoder, the resulting neural network is better able to imitate the behavior of the set of trajectories in a robust manner over a wider range of behaviors. As a wider range of behaviors are modelled by the neural network, a smaller number of training trajectories are required to train the neural network. Accordingly, this method allows for one-shot learning. Furthermore, this method allows for re-use in compositional controllers.

The methods described herein provide improved training compared to, for instance, behavioral cloning. Behavioral cloning suffers from inefficiencies stemming from its sequential nature and an inability to correct errors effectively without the training data set demonstrating appropriate correcting behaviors. In contrast, by training the neural network using an encoder that has been trained on the training trajectories, the methods described herein are better able to learn multiple behaviors robustly from small training datasets. Accordingly, the methods described herein are more efficient and effective at training neural networks.

Adjusting parameters of the neural network may use values output from a discriminator that have been conditioned using the embeddings. Conditioning the discriminator values using the latent variables results in the neural network becoming more robust and exhibiting a greater diversity of modelled behaviors. More specifically, conditioning the discriminator values also allows for the generation of a variety of reward functions, each of them tailored to imitating a different trajectory. The increased diversity of the reward functions provides a more stable means for training the neural network, as the method will not collapse into one particular mode. This allows for a greater diversity in the behaviors that are modelled.

Adjusting the parameters of the neural network may comprise determining a set of parameters that improves the return from a reward function, the reward function being based on a value output from the discriminator. Accordingly, the neural network may be trained via reinforcement learning using a reward function that is based on the discriminator (that is, a variety of reward functions that are dependent on the discriminator values for the corresponding trajectories). As the discriminator has been conditioned using the latent variables, the reward function is also dependent on the latent variables that have been encoded from the set of trajectories. This leads to increased robustness of the neural network. The parameters may be determined via a stochastic gradient ascent or descent process. More specifically, the parameters may be determined via a trust region policy optimization process.

More specifically, the reward function may be:

rₜ^{j}(xₜ^{j}, aₜ^{j}|zⱼ)=−log(1−D_{ψ}(xₜ^{j}, aₜ^{j}|zⱼ))

wherein:

rₜ^{j}(xₜ^{j}, aₜ^{j}|zₜ^{j}) is the t^{th} reward for the j^{th} trajectory τⱼ={x₁^{j}, a₁^{j}, . . . , x_{T}_{ⱼ}^{j}, a_{T}_{ⱼ}^{j}};

xₜ^{j} is the t^{th} state from a total of Tⱼ state action pairs for the j^{th} trajectory;

aₜ^{j} is the t^{th} action from a total of Tⱼ state action pairs for the j^{th} trajectory;

z^{j} is the embedding calculated by applying the encoder q to the j^{th} trajectory, z^{j}˜q(·|x_{1:T}_{ⱼ}^{j}); and

D_{ψ} is the output of the discriminator.

The method may further comprise updating a set of discriminator parameters based on the embeddings. This allows the method to be iteratively repeated to further improve the neural network.

The method may comprise iteratively: updating the parameters of the neural network based on the discriminator; updating the discriminator parameters based on the set of trajectories, the set of imitation trajectories and the embeddings; and updating the embeddings and imitation trajectories using the updated neural network, until an end condition is met. The end condition may be a maximum number of iterations or maximum amount of time allocated for training the neural network. The method may further comprise, in response to the end condition being met, updating the parameters of the neural network based on the updated discriminator and outputting the parameters of the neural network.

Updating the set of discriminator parameters may utilize a gradient ascent method. More specifically, updating the set of discriminator parameters may comprise implementing:

$${min}_{θ} {max}_{ψ} {{r}_{i} \text{∼} {π}_{E}}_{} \{ {q ( x \vert {x}_{1 \text{:} {T}_{i}}^{i} )}_{} [ \frac{1}{{T}_{i}} {\sum }_{t = 1}^{{T}_{i}} log {D}_{ψ} ( {x}_{t}^{i} , {a}_{t}^{i} \vert z ) + {{π}_{θ}}_{} [ log ( 1 - {D}_{ψ} ( x , a \vert z ) ) ] ] \}$$

wherein:

D_{ψ} is the discriminator function;

ψ is the set of discriminator parameters;

π_{θ} is the policy of the neural network;

θ is the set of parameters for the neural network;

π_{Ε} represents the expert policy that generated the set of trajectories;

q is the encoder;

τᵢ is the i^{th} trajectory, τᵢ={x₁ⁱ, a₁ⁱ, . . . , x_{T}_{ᵢ}ⁱ, a_{T}_{ᵢ}ⁱ}, where xₙⁱ is the n^{th} state and aₙⁱ is the n^{th}action from a total of Tᵢ state action pairs; and

z is an embedding.

Accordingly, the method may comprise minimizing the above function with respect to θ and maximizing the above function with respect to ψ.

Updating the set of discriminator parameters may utilize a gradient ascent method with gradient:

$${∇}_{ψ} \{ \frac{1}{n} {\sum }_{j = 1}^{n} [ \frac{1}{{T}_{j}} {\sum }_{t = 1}^{{T}_{j}} log {D}_{ψ} ( {x}_{t}^{j} , {a}_{t}^{j} \vert {z}_{j} ) ] + [ \frac{1}{{\hat{T}}_{j}} {\sum }_{t = 1}^{{\hat{T}}_{j}} log ( 1 - {D}_{ψ} ( {\hat{x}}_{t}^{j} , {\hat{a}}_{t}^{j} \vert {z}_{j} ) ) ] \}$$

wherein:

D_{ψ} is the discriminator function;

ψ is the set of discriminator parameters;

θ is the set of parameters for the neural network;

each trajectory, τⱼ, of the set of trajectories is τⱼ={x₁^{j}, a₁^{j}, . . . , x_{T}_{ⱼ}^{j}, a_{T}_{ⱼ}^{j}}, where xₙ^{j} is the n^{th} state and aₙ^{j} is the n^{th}action from a total of Tⱼ state action pairs;

each imitation trajectory, \hat{τ}ⱼ, is \hat{τ}ⱼ={\hat{x}₁^{j}, â₁^{j}, . . . , \hat{x}_{\hat{T}}_{ⱼ}^{j}, â_{\hat{T}}_{ⱼ}^{j}}, where \hat{x}ₙ^{j} is the n^{th} imitation state and âₙ^{j} is the n^{th} imitation action from a total of \hat{T}ⱼ imitation state action pairs; and

zⱼ is the embedding of the trajectory τⱼ.

By updating the discriminant parameters via the above method, the updated discriminator may be utilized to determine improved neural network parameters.

Obtaining the encoder may comprise training a variational auto encoder based on the set of trajectories, wherein the encoder forms part of the variational auto encoder. Accordingly, whilst a pre-trained encoder may be utilized, the method may also include training the encoder based on a training set of trajectories. This may be achieved by training a variational auto encoder. Variational auto encoders generally include an encoder for producing a set of latent variables from a set of training trajectories, and the decoder for decoding the latent variables to produce imitation trajectories.

The variational auto encoder may further comprise a state decoder for decoding the embeddings to produce imitation states and an action decoder for decoding the embeddings to produce imitation actions. The imitation states and imitation actions combine as state action pairs to form imitation trajectories.

The action decoder may be a multilayer perceptron and the state decoder may be an autoregressive neural network, such as a wavenet.

The policy may be based on the action decoder. This allows the training of the neural network to be bootstrapped on the back of the action decoder that has already been trained on the trajectories. Initially, the policy may incorporate weights taken from the action decoder. Having said this, taking weights directly from the action decoder can lead to poor performance initially and destroy behavior present in the action decoder due to noise injected into the policy.

Advantageously the policy π_{θ} may be:

π_{θ}(·|x, z)= [symbol] (·|μ_{θ}(x, z)+μ_{α}(x, z), σ₇₄ (x, z))

wherein:

x is a state from the trajectory;

z is the embedding calculated by applying the encoder to the trajectory;

μ_{θ} is a mean output from the neural network;

μ_{α} is the mean of the output of the action decoder; and

σ_{θ} is a variance of output of the neural network.

This provides improved performance and helps avoid issues caused by noise.

Weights of the action decoder may be kept constant after the action decoder has been determined. By freezing the weights of the action decoder, deterioration of the action decoder can be prevented.

The encoder may be a bi-directional long short term memory encoder.

In general, another innovative aspect of the subject matter described in this specification can be embodied in a method of reinforcement learning, the method comprising: obtaining the encoder of a trained variational autoencoder neural network, wherein the variational autoencoder neural network was trained using a plurality of trajectories of state-action pairs, the variational autoencoder comprising an encoder comprising a recurrent neural network to encode a probability distribution of the trajectories as an embedding vector defining parameters representing the probability distribution, and a decoder to sample from the probability distribution to provide decoded state-action pairs; determining a target embedding vector for a target trajectory by sampling from the probability distribution encoded for the target trajectory by the encoder; and training a reinforcement learning neural network using reward values conditioned on the target embedding vector.

The reinforcement learning neural network may comprise a neural network comprising a policy generator and a discriminator. The policy generator may be used to select actions to be performed by an agent interacting with an environment to imitate a state-action trajectory, using the discriminator to discriminate between the imitated state-action trajectory and a reference trajectory, and updating parameters of the policy generator using the reward values conditioned on the target embedding vector.

The decoder may comprise an action decoder and a state decoder, and the state decoder may comprise an autoregressive neural network to learn state representations for the decoder.

A corresponding system for reinforcement learning comprises the encoder of a variational autoencoder neural network, in particular a trained variational autoencoder neural network, the encoder comprising a recurrent neural network configured to encode a probability distribution of trajectories of state-action pairs as an embedding vector defining parameters representing the probability distribution, wherein the reinforcement learning system is configured to determine a target embedding vector for a target trajectory by sampling from the probability distribution encoded for the target trajectory by the encoder, and to train a reinforcement learning neural network using reward values conditioned on the target embedding vector. The system may include a policy generator and a discriminator as previously described. The decoder may comprise an autoregressive neural network to learn state representations.

In general, one innovative aspect of the subject matter described in this specification can be embodied in a system comprising one or more computers and one or more storage devices storing instructions that when executed by the one or more computers cause the one or more computers to perform the operations of the respective method of any one of the methods described herein.

In general, one innovative aspect of the subject matter described in this specification can be embodied in one or more computer storage media storing instructions that when executed by one or more computers cause the one or more computers to perform the operations of the respective method of any one of the methods described herein.

Once the neural network has been trained, it may be used to determine actions in response to input states. This may be used to control an agent such as a robot, an autonomous vehicle, or a computer avatar. Whilst the implementations described herein discuss determining actions that correspond to specific input states, interpolated actions may also be generated. Interpolated actions may be based on an interpolated state (a state formed by interpolating two input states) or an interpolated embedding (an embedding formed by interpolating between two embeddings of two corresponding states).

The subject matter described in this specification can be implemented in particular embodiments so as to realize one or more of the following advantages. The methods can be used to more efficiently and effectively train a neural network. For example by utilizing an encoder to train the neural network, the resulting neural network is better able to imitate the behavior of a smaller number of training trajectories in a robust manner over a wider range of behaviors. As a smaller number of training trajectories is required, the neural network can learn more quickly from observed actions, whilst also avoiding errors usually associated when small training sets are used. Accordingly, the resulting neural network is more robust and displays an increased diversity in behavior. Utilizing a smaller set of training trajectories means that a smaller number of computations is required, therefore the methods described herein display improved computational efficiency.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for training a neural network used to select actions to be performed by an agent interacting with an environment.

FIG. 3 shows a state encoder and a state and action decoder according to an implementation.

FIG. 4 shows a flow diagram of an example process for training a neural network using embedded trajectories.

Like reference numbers and designations in the various drawings indicate like elements.

### DETAILED DESCRIPTION

This specification generally describes a reinforcement learning system implemented as computer programs on one or more computers in one or more locations that selects actions to be performed by a reinforcement learning agent interacting with an environment by using a neural network. This specification also describes how such a system can adjust the parameters of the neural network.

The system has an advantage that an agent such as a robot, or autonomous or semi-autonomous vehicle can improve its interaction with a simulated or real-world environment. It can enable for example the accomplishment of a specific task or improvement of navigation through or interaction with the environment.

Some implementations of the system address the problem of assigning credit for an outcome to a sequence of decisions which led to the outcome. More particularly they aim to improve the estimation of the value of a state given a subsequent sequence of rewards, and hence improve the speed of learning and final performance level achieved. They also reduce the need for hyperparameter fine tuning, and hence are better able to operate across a range of different problem domains.

In some implementations, the environment is a real-world environment and the agent is a mechanical agent interacting with the real-world environment. For example, the agent may be a robot interacting with the environment to accomplish a specific task. As another example, the agent may be an autonomous or semi-autonomous vehicle navigating through the environment. In these cases, the observation can be data captured by one or more sensors of the mechanical agent as it interacts with the environment, e.g., a camera, a LIDAR sensor, a temperature sensor, and so on.

In other implementations, the environment is a simulated environment and the agent is implemented as one or more computers interacting with the simulated environment. For example, the simulated environment may be a video game and the agent may be a simulated user playing the video game.

Continuous control via deep reinforcement learning has made much progress in the last few years with several impressive demonstrations of how sophisticated motor skills can be learned from scratch or from demonstrations in simulation and, to some extent, on real robots.

Yet, the flexibility and agility of animals remains unmatched. One hallmark of biological motor control is that animals are able to recruit a large variety of different movements as required by the circumstances. Imagine a football player in action: she will run forward or backwards, at different speeds, perform quick turns, dribble the ball, feint the goal keeper and finally kick the ball into the goal. Building versatile embodied agents, both in the form of real robots and in the form of animated avatars, capable of a wide and diverse set of behaviors is one of the long-standing challenges of AI.

Behavioral cloning (BC) is a training method in which the actions of an agent mimicked. Given a set of demonstration trajectories {τᵢ}ᵢ where the i-th trajectory of state-action pairs is τᵢ={x₁ⁱ, a₁ⁱ, . . . , x_{T}_{ᵢ}ⁱ, a_{T}_{ᵢ}ⁱ}, behavioral cloning seeks apply Maximum Likelihood to imitate the actions. In the i^{th} trajectory, {τᵢ}ᵢ:

xₙⁱ is the n^{th} state,

aₙⁱ is the n^{th} action,

Tᵢ is the number of state-action pairs.

When demonstration data is abundant, BC can be effective; however, without an abundance of data, BC can often fail. The inefficiencies of BC stem from the sequential nature of the problem. When using BC, even the slightest errors in mimicking the demonstration behavior can quickly accumulate as the policy is unrolled. A good policy should correct for the mistakes made previously. For BC to learn good corrective policies, there have to be enough corresponding behaviors in the demonstrations. Unfortunately, corrective behaviors are often rare in demonstration trajectories, thus making the learning of good corrective policies difficult.

From a learning perspective the goal of endowing an agent with a diverse set of behaviors therefore poses several challenges as it often requires the acquisition of the behaviors in the first place. The methods described herein seek to overcome this problem.

The starting point is the assumption that a moderate number of demonstrations of a variety of different behaviors is available in the form of state-action sequences, or simply sequences of states. The goal is to learn a control policy that can be conditioned on a behavior embedding vector and, when conditioned appropriately, reproduce any behavior from the original set, and, at least to some extent, interpolate between them.

By training the system based on embeddings (latent variables) determined via an encoder, the resulting system is better able to imitate the behavior of the set of trajectories in a robust manner over a wider range of behaviors. As a wider range of behaviors are modelled by the neural network, a smaller number of training trajectories are required to train the neural network, therefore providing a more efficient training method. Furthermore, this method allows for one-shot learning.

In addition, instead of pre-defining the behavior embedding space, some implementations described herein allow this behavior to emerge by training a control policy jointly with the encoder that maps a demonstration trajectory onto an embedding vector. The policy is then trained to approximately reproduce the trajectory. Besides being a vehicle for learning a suitable embedding space the encoder can subsequently serve to perform one-shot imitation of a given test trajectory.

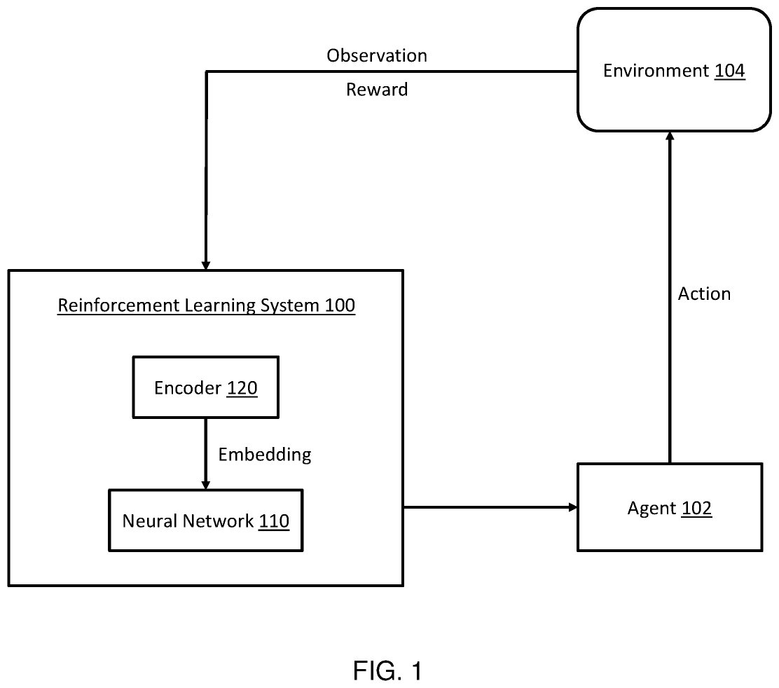

FIG. 1 shows an example reinforcement learning system 100. The reinforcement learning system 100 is an example of a system implemented as computer programs on one or more computers in one or more locations in which the systems, components, and techniques described below are implemented.

The reinforcement learning system 100 selects actions to be performed by a reinforcement learning agent 102 interacting with an environment 104. That is, the reinforcement learning system 100 receives observations, with each observation characterizing a respective state of the environment 104, and, in response to each observation, selects an action from an action space to be performed by the reinforcement learning agent 102 in response to the observation. The reinforcement learning system 100 then instructs or otherwise causes the agent 102 to perform the selected action.

After the agent 102 performs a selected action, the environment 104 transitions to a new state and the system 100 receives another observation characterizing the next state of the environment 104 and a reward. The reward can be a numeric value that is received by the system 100 or the agent 102 from the environment 104 as a result of the agent 102 performing the selected action. That is, the reward received by the system 100 generally varies depending on the result of the transition of states caused by the agent 102 performing the selected action. For example, a transition into a state that is closer to completing the task being performed by the agent 102 may result in a higher reward being received by the system 100 than a transition into a state that is farther from completing the task being performed by the agent 102.

In particular, to select an action, the reinforcement learning system 100 includes a neural network 110 and an encoder 120. The encoder 120 generates an embedding for each received action and provides each embedding to the neural network 110. Each embedding describes the corresponding action via a set of latent variables. Generally, the neural network 110 is a neural network that is configured to receive an embedding of an observation and to process the embedding to generate an output that defines the action that should be performed by the agent in response to the observation.

In some implementations, the neural network 110 is a neural network that receives an embedded observation and an action and outputs a probability that represents a probability that the action is the one that maximizes the chances of the agent completing the task.

In some implementations, the neural network 110 is a neural network that receives an embedded observation and generates an output that defines a probability distribution over possible actions, with the probability for each action being the probability that the action is the one that maximizes the chances of the agent completing the task.

In some other implementations, the neural network 110 is a neural network that is configured to receive an embedding of an observation and an action performed by the agent in response to the observation, i.e., an observation-action pair, and to generate a Q-value for the observation-action pair that represents an estimated return resulting from the agent performing the action in response the observation in the observation-action pair. The neural network 110 can repeatedly perform the process, e.g. by repeatedly generating Q-values for observation-action pairs. The system 100 can then use the generated Q-values to determine an action for the agent to perform in response to a given observation.

To allow the agent 102 to effectively interact with the environment, the reinforcement learning system 100 jointly trains the neural network 110 and the encoder 120 to determine trained values of the parameters of the neural network 110 and the trained encoder 120.

After the agent 102 has performed an action in response to a given observation and a reward has been received by the system 100 as a result of the agent performing the action, the system trains the neural network 110 based on the observation and reward.

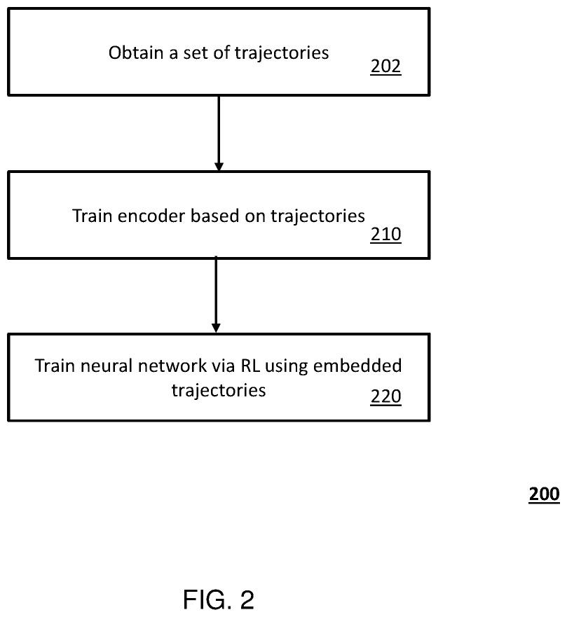

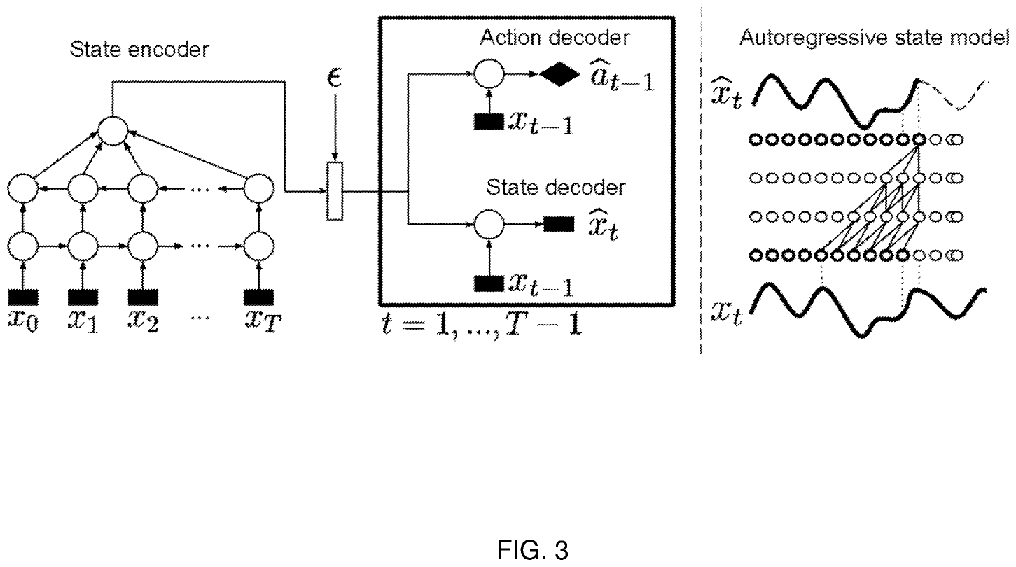

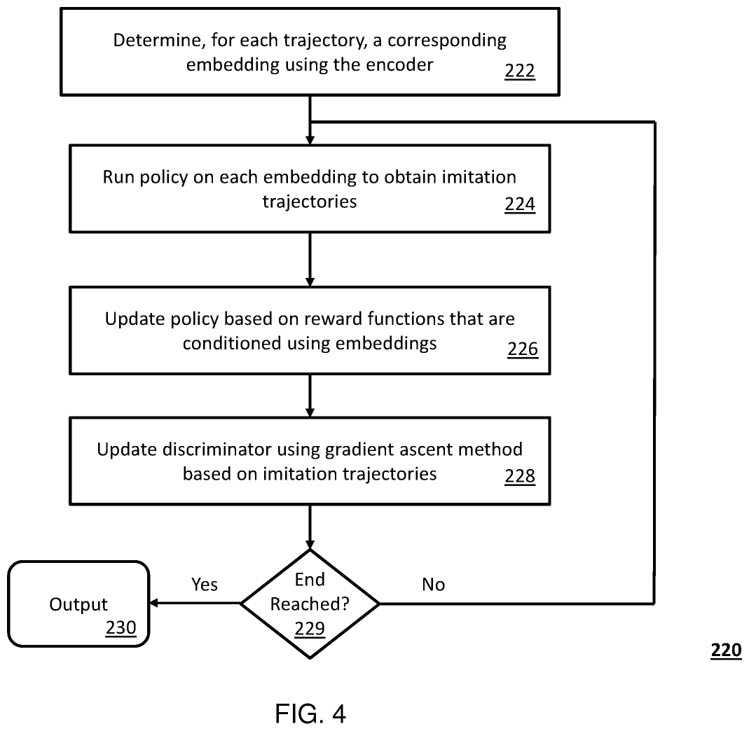

Training the reinforcement learning system 100 is described in more detail below with reference to FIG. 2. Training the encoder 120 is described in more detail below with reference to FIG. 3. Training the neural network 110 is described in more detail below with reference to FIG. 4.

FIG. 2 shows a flow diagram of an example process for training a reinforcement learning system to select actions to be performed by an agent interacting with an environment. For convenience, the process 200 will be described as being performed by a system of one or more computers located in one or more locations. For example, a reinforcement learning system, e.g., the reinforcement learning system 100 of FIG. 1, appropriately programmed in accordance with this specification, can perform the process 200.

The goal of the training is to learn a single policy that is capable of mimicking a diverse set of behaviors, even when there is not enough data for traditional methods to work well. To this end, a two-stage approach is introduced. First an encoder is trained based on a set of input trajectories. Then the neural network is trained via reinforcement learning using encodings generated by the trained encoder.

The method therefore starts by obtaining a set of trajectories 202. The trajectories are training or demonstration trajectories exhibiting behavior to be imitated. Each trajectory comprises data identifying (i) a first observation characterizing a first state of the environment and (ii) a first action performed by the agent in response to the first observation. In some implementations, e.g., in implementations where the neural network is being trained using an off-policy algorithm, the system can obtain the data from a memory that stores state-action pairs generated from the agent interacting with the environment. In other implementations, e.g., in implementations where the neural network is being trained using an on-policy algorithm, the obtained data includes data that has been generated as a result of a most-recent interaction of the agent with the environment.

Next, the system trains the encoder based on the trajectories 210. In one implementation, a variational autoencoder (VAE) is utilized comprising a bi-directional long short term memory (LSTM) encoder for the demonstration trajectories and two decoders: a multilayer perceptron (MLP) for the actions and a Wavenet to predict the next state. The system is configured to pass the trajectories through the encoder to determine a distribution over embeddings z of the demonstration trajectories, then decode the trajectories to obtain imitation trajectories, and then train the system to improve the encoder and decoder performance. This supervised stage is essentially like behavioral cloning (BC) in terms of the objective being optimized, but architecturally includes an encoder which outputs stochastic embeddings to improve diversity. This shall be discussed in more detail below with reference to FIG. 3.

Next, the system trains the neural network via reinforcement learning using embedded trajectories 220. That is, the trained encoder is used to determine embeddings of each trajectory (embedded trajectories) and the neural network is trained using the embedded trajectories. While the first stage is fully supervised, the second stage is about tuning the model via reinforcement learning to increase robustness. This shall be discussed in more detail with reference to FIG. 4.

Whilst the implementation of FIG. 2 includes the training of the encoder, it should be noted that the training methods described herein would equally work by training the neural network based on embeddings generated using a pre-trained encoder. Accordingly, it is not essential for the reinforcement learning system 100 to train the encoder, as the encoder may be trained by an external system, i.e. a pretrained encoder may be provided to the reinforcement learning system 100 (e.g. loaded into memory) in advance.

### Supervised Stage of Imitation

Conventional BC without a demonstration trajectory encoder, while simple, has a number of shortcomings. It is difficult for the estimated policy to mimic the expert under minor environmental deviations. For example, suppose the expert was driving a car in the middle of the lane. If the agent trained with BC encounters itself outside the middle of the lane, it will with high probability leave the road altogether; a rather undesirable situation. In addition, there is no obvious way to harness the policies learned with conventional BC within hierarchical controllers.

To overcome this problem, an encoder can be used to encode the demonstration trajectory to form embeddings upon which the BC policy depends. This approach facilitates transfer and one-shot learning.

In the present implementation, to better regularize the latent space, stochastic variational autoencoders (VAEs) having a distribution q(z|x_{1:T}) are utilized. The encoder maps a demonstration trajectory to a vector. Given this vector, both the state and action trajectories can be decoded, as shown in FIG. 3. To achieve this, the system minimizes the following loss function, [symbol] (α, ω, ϕ; τᵢ):

$$( α , ω , φ ; {τ}_{i} ) = - {{q}_{φ} ( z \vert {x}_{i \text{:} {T}_{i}}^{i} )}_{} [ {\sum }_{t = 1}^{{T}_{i}} log {π}_{α} ( {a}_{t}^{i} \vert {x}_{t}^{i} , z ) + log {p}_{ω} ( {x}_{t + 1}^{i} \vert {x}_{t}^{i} , z ) ] + {D}_{KL} ( {q}_{φ} ( z \vert {x}_{1 \text{:} {T}_{i}}^{i} ) \vert \vert p ( z ) )$$

where:

π_{α} represents the action decoder with parameters α;

p_{ω} represents the state decoder with parameters ω;

q_{ϕ} represents the encoder with parameters ϕ;

D_{KL}( ) is the Kullback-Leibler divergence; and

τᵢ is the i^{th} trajectory, τᵢ={x₁ⁱ, a₁ⁱ, . . . , x_{T}_{ᵢ}ⁱ, a_{T}_{ᵢ}ⁱ}, where xₙⁱ is the n^{th} state and aₙⁱ is the n^{th} action from a total of Tᵢ state action pairs.

FIG. 3 shows a state encoder and a state and action decoder according to an implementation.

The state encoder network q takes the form of a bi-directional long short term memory (LSTM) neural network. The encoder takes a set of states and generates a corresponding set of embedded states (embeddings). The encoder has two layers.

To produce the final encoding, the average of all the outputs of the second layer of the bi-directional LSTM is determined before a final linear transformation is applied to generate the mean and standard deviation of a Gaussian representing the encoding. The system then takes a sample from this Gaussian as the encoding ϵ.

During training the encoding is input into a state decoder and an action decoder to determine imitation states and imitation actions. These are then used to train the encoder, as discussed above.

The action decoder is a multi-layer perceptron (MLP), which takes both the state and the encoding as inputs and produces the parameters of a Gaussian.

The state decoder is shown on the right hand side of FIG. 3. The state decoder is similar to a conditional Wavenet. The conditioning is produced by the concatenation of the state xₜ and the encoding before being passed into an MLP. The remainder of the network is similar to the standard conditional Wavenet architecture. A Wavenet is a type of autoregressive convolutional neural network. Instead of Softmax outputs units, a mixture of Gaussians is used as the output of the Wavenet. Wavenets are described in A. van den Oord, S. Dieleman, H. Zen, K. Simonyan, O. Vinyals, A. Graves, N. Kalchbrenner, A. Senior, and K. Kavukcuoglu. “WaveNet: A generative model for raw audio”.

The outputs of the encoder and decoders are then used in the training to find the parameters that minimize the above loss function [symbol] (α, ω, ϕ; τᵢ).

Once trained, the parameters of the encoder can be stored for future in training the neural network 110.

It should be noted that whilst the above implementation discusses the use of a bi-directional long short term memory (LSTM) neural network, alternative forms of encoder may be used. In addition, whilst the above implementation discusses the use of a conditional Wavenet, alternative forms of state decoder may be used. Furthermore, whilst the above implementation discusses the use of a multi-layer perceptron, alternative forms of action decoder may be used.

### Control Stage of Imitation

As discussed above, BC performs poorly without a large set of demonstrations. Even with a demonstration trajectory encoder, as in the present case, BC can result in policies that make irrecoverable failures.

To solve this problem the implementations described herein include a second stage of policy refinement with reinforcement learning, which leads to significant improvements in robustness.

To this end, the implementations described herein adapt concepts used in Generative Adversarial Imitation Learning (GAIL).

GAIL is a method that can avoid the pitfalls of BC by interacting with the environment. Specifically, GAIL constructs a reward function using Generative Adversarial Networks (GANs) to measure the similarity between the policy generated trajectories and the expert trajectories.

GANs are generative models that use two networks: a generator G and a discriminator D. The generator tries to generate samples that are indistinguishable from real data. The job of the discriminator is to tell apart the data and the samples, predicting 1 with a high probability if the sample real and 0 otherwise. More precisely, GAN optimizes the following objective function:

$${min}_{G} {max}_{D} {{p}_{data} ( x )}_{} [ log D ( x ) ] + {p ( z )}_{} [ log ( 1 - D ( G ( z ) ) ]$$

GAIL is an imitation learning version of GAN that seeks to imitate expert trajectories. GAIL adopts the following objective function:

$${min}_{θ} {max}_{ψ} {{π}_{E}}_{} [ log {D}_{ψ ( x , a )} ] + {{π}_{θ}}_{} [ log ( 1 - {D}_{ψ} ( x , a ) ) ]$$

where π_{Ε} denotes the expert policy that generated the demonstration trajectories and π_{θ} denotes the policy to be trained. To avoid differentiating through the system dynamics, policy gradient algorithms, instead of backpropagation, are used to train the policy by maximizing the discounted sum rewards:

r_{ψ}(xₜ, aₜ)=−log(1 −D_{ψ(}xₜ, aₜ))

wherein:

r_{ψ}(xₜ, aₜ|zₜ) is the reward for the trajectory τ={x₁, a₁, . . . , x_{T}_{ⱼ}, a_{T}_{ⱼ}};

xₜ is the t^{th} state from a total of Tⱼ state action pairs for the trajectory;

aₜ is the t^{th} action from a total of Tⱼ state action pairs for the trajectory; and

D_{ψ}is the output of the discriminator with discriminator parameters ψ.

Maximizing this reward, which may differ from the expert reward, drives π_{θ} to expert-like regions of the state-action space. In practice, trust region policy optimization (TRPO) is used to stabilize the learning process.

Whilst GAIL can overcome some issues regarding BC, it has been found to be inadequate for training the system described herein. The GAIL optimizer based on policy gradients is mode seeking. It is therefore difficult to recover a diverse set of behaviors using this approach. This problem is further exacerbated by the mode collapse problem of GANs.

To solve this problem, a new approach is proposed that is capable of imitating diverse behaviors via reinforcement learning. The implementation utilized herein conditions the discriminator on encodings generated by the pre-trained encoder. Specifically, the discriminator is trained by optimizing the following objective:

$${min}_{θ} {max}_{ψ} {{τ}_{i} \text{∼} {π}_{E}}_{} \{ {q ( z \vert {x}_{1 \text{:} {T}_{i}}^{i} )}_{} [ \frac{1}{{T}_{i}} {\sum }_{t = 1}^{{T}_{i}} log {D}_{ψ} ( {x}_{t}^{i} , {a}_{t}^{i} \vert z ) + {{π}_{θ}}_{} [ log ( 1 - {D}_{ψ} ( x , a \vert z ) ) ] ] \}$$

wherein:

D_{ψ} is the discriminator function;

ψ is the set of discriminator parameters;

π_{θ} is the policy of the neural network;

θ is the set of parameters for the neural network;

π_{Ε} represents the expert policy that generated the set of training trajectories;

q is the encoder;

τᵢ is the i^{th} trajectory, τᵢ={x₁ⁱ, a₁ⁱ, . . . , x_{T}_{ᵢ}ⁱ, a_{T}_{ᵢ}ⁱ}, where xₙⁱ is the n^{th} state and aₙⁱis the n^{th} action from a total of Tᵢ state action pairs; and

z an embedding.

Since the discriminator is conditional, the reward function r_{ψ}^{t}(xₜ, aₜ|z) is now also conditional:

r_{ψ}^{t}(xₜ, aₜ|z)=−log(1−D_{ψ}(x, a|z)

The conditioning therefore allows the generation of set of customized reward functions, each customized reward function being tailored to imitating a different trajectory. The policy gradient algorithm, though mode seeking, will not cause collapse into one particular mode due to the diversity of reward functions.

Since the system already has an action decoder from supervised training, it can be used to bootstrap the learning by RL. One possible route is to initialize the weights of the policy network to be the same as those of the action decoder. Before the policy reaches good performance, however, the noise injected into the policy for exploration (assuming that a stochastic policy gradient is used to train the policy) can lead to poor performance initially and destroy the behavior already present in the action decoder. Instead, a new policy is chosen to be:

π_{θ}(·|x, z)= [symbol] (·|μ_{θ}(x, z), +μ_{α}(x, z), σ_{θ}(x, z)

where:

x is a state from the trajectory;

z is the embedding calculated by applying the encoder to the trajectory;

μ_{θ} is a mean output from the neural network;

μ_{α} is the mean of the output of the action decoder; and

σ^{θ} is a variance of output of the neural network.

To prevent the deterioration of the action decoder, its weights are frozen during training. That is, the weights of the action decoder are kept constant as the neural network is trained.

For policy optimization, trust region policy optimization may be adopted.

FIG. 4 shows a flow diagram of an example process for training a neural network using embedded trajectories. This process can be considered equivalent to step 220 in FIG. 2.

The process begins, as discussed with regard to FIG. 2, with the receipt of a set of trajectories and a trained encoder.

Then, for each trajectory, a corresponding embedding is determined 222. This is achieved by applying the encoder to the trajectory to obtain an embedded trajectory.

Then, policy is applied to the embedded trajectories to obtain corresponding imitation trajectories 224. That is, for each embedded trajectory, the embedded trajectory is input into the neural network, which applies the policy and outputs a corresponding imitation trajectory. If this is the first iteration of the method, then the policy is initiated as discussed above; otherwise, the previously updated policy is applied.

The policy parameters are then updated based on reward functions that are conditioned on the embeddings 226. As discussed, the policy may be updated using trust region policy optimization (TRPO). This aims to determine a set of policy parameters that improve the return from the reward function. The reward function is conditioned on the discriminator that, in turn is conditioned on the embeddings, so that a customized reward function is applied for each embedding (for each trajectory). As discussed above, the reward function is:

rₜ^{j}(xₜ^{j}, aₜ^{j}|zⱼ)=−log(1−D_{ψ}(xₜ^{j}, aₜ^{j}|zⱼ))

wherein:

rₜ^{j}(xₜ^{j}, aₜ^{j}|zₜ^{j}) is the t^{th} reward for the j^{th} trajectory τⱼ={x₁^{j}, a₁^{j}, . . . , x_{T}^{j}, a_{T}_{ⱼ}^{j}};

xₜ^{j} is the t^{th} state from a total of Tⱼ state action pairs for the j^{th} trajectory;

aₜ^{j} is the t^{th} action from a total of Tⱼ state action pairs for the j^{th} trajectory;

z^{j} is the embedding calculated by applying the encoder q to the j^{th} trajectory, z^{j}˜q(·|x_{1:T}_{ⱼ}^{j}); and

D_{ψ} is the output of the discriminator.

For every trajectory, a different reward function is used, and for every state action pair within the trajectory, a different reward is determined using the corresponding reward function.

The discriminator is the updated using a gradient ascent method based on the imitation trajectories output by the neural network 228. The discriminator is also conditioned on the embeddings. The discriminator is updated by adjusting the parameters of the discriminator neural network using backpropagation of the gradient using a gradient ascent or descent method.

In the present case, the gradient is:

$${∇}_{ψ} \{ \frac{1}{n} {\sum }_{j = 1}^{n} [ \frac{1}{{T}_{j}} {\sum }_{t = 1}^{{T}_{j}} log {D}_{ψ} ( {x}_{t}^{j} , {a}_{t}^{j} \vert {z}_{j} ) ] + [ \frac{1}{{\hat{T}}_{j}} {\sum }_{t = 1}^{{\hat{T}}_{j}} log ( 1 - {D}_{ψ} ( {\hat{x}}_{t}^{j} , {\hat{a}}_{t}^{j} \vert {z}_{j} ) ) ] \}$$

wherein:

D_{ψ} is the discriminator function;

ψ is the current set of discriminator parameters;

θ is the set of parameters for the neural network;

τⱼ is the j^{th} trajectory of the set of trajectories, wherein τⱼ={x₁^{j}, a₁^{j}, . . . , x_{T}^{j}, a_{T}_{ⱼ}^{j}}, where xₙ^{j} is the n^{th} state and aₙ^{j} is the n^{th} action from a total of Tⱼ state action pairs;

\hat{τ}ⱼ is the j^{th} imitation trajectory, wherein \hat{τ}ⱼ={\hat{x}₁^{j}, â₁^{j}, . . . , \hat{x}_{\hat{T}}_{ⱼ}^{j}, â_{\hat{T}}_{ⱼ}^{j}}, where \hat{x}ₙ^{j} is the n^{th} imitation state and âₙ^{j} is the n^{th} imitation action from a total of \hat{T}ⱼ imitation state action pairs;

zⱼ is the embedding of the trajectory τⱼ; and

∇_{ψ} is the gradient with respect to ψ.

Once the discriminator has been updated, the system determines whether the end of the training has been reached 229. The end is reached when an end criterion has been satisfied. This might be, for instance, a predefined number of iterations of training or a predefined time for training.

If the end has not been reached, the method loops back to repeat steps 224-229 using the updated discriminator parameters and updated policy parameters. The updated policy is utilized in step 224 and the updated discriminator is applied in the reward functions used in step 226.

The method therefore repeatedly updates the policy and discriminator parameters, iteratively improving on them until the end criterion is satisfied.

Once the end has been reached, the method outputs the policy parameters 230. This output may be to memory, either local or otherwise, or via communication to another device or system. The output policy parameters may then be utilized as a trained model for imitating the behaviors indicated by the input training trajectories.

Algorithm 1 shows an example process for training a neural network using embedded traj ectories.

The algorithm first receives a set of demonstration trajectories and a pre-trained encoder (e.g. trained during step 210 or input to the system).

The algorithm then, for each trajectory, determines an embedding and then runs the policy on the embedding to determine a corresponding imitation trajectory. This repeats until an embedding and an imitation trajectory has been determined for all input trajectories.

Then the policy parameters are updated via TRPO using rewards determined from the reward function conditioned on the embeddings and the discriminator parameters are updated with the gradient.

The method repeats until a maximum number of iterations or a maximum time has been reached.

ALGORITHM 1

```
Control stage of diverse imitation.
INPUT: Demonstration trajectories {τᵢ}ᵢ and a pre-trained encoder q.
repeat
  for j ∈ {1, . . . , n} do
    Sample trajectory τⱼ from the demonstration set and sample zⱼ ~ q(•|x_{1:T}_{ᵢ}^{j}).
    Run policy π_{θ} (•|zⱼ) to obtain the trajectory \hat{τ}ⱼ.
  end for
  Update policy parameters via TRPO with rewards rₜ^{j}(xₜ^{j}, aₜ^{j}|zⱼ) = −log(1 − D_{ψ}(xₜ^{j}, aₜ^{j}|zⱼ)).
  Update discriminator parameters from ψᵢ to ψᵢ₊₁ with gradient:
      ${∇}_{ψ} \{ \frac{1}{n} {\sum }_{j = 1}^{n} [ \frac{1}{{T}_{j}} {\sum }_{t = 1}^{{T}_{i}} log {D}_{ψ} ( {x}_{t}^{j} , {a}_{t}^{j} \vert {z}_{j} ) ] + [ \frac{1}{{\hat{T}}_{j}} {\sum }_{t = 1}^{{\hat{T}}_{i}} log ( 1 - {D}_{ψ} ( {\hat{x}}_{t}^{j} , {\hat{a}}_{t}^{j} \vert {z}_{j} ) ) ] \}$
until Max iteration or time reached.
```

The implementations described herein provide a means for training a neural network to imitate diverse sets of behaviors using fewer training trajectories. This means that the neural network can be trained more efficiently. Furthermore, if a large number of trajectories are used then the neural network can imitate the training behaviors more effectively.

The training methods described herein have been tested to quantify their advantages. After training, it has been found that the trained model is more capable of reproducing most training and test policies.

In addition, To assist better generalization, it would be beneficial for the encoder to encode the trajectories in a semantically meaningful way. To test whether this is indeed the case, two random training trajectories were compared and their embedding vectors were obtained using the encoder. A series of convex combinations of these embedding vectors interpolating from one to the other were produced. The action decoder was conditioned on each of these intermediary points and executed in the environment. It was shown that interpolating in the latent space indeed corresponds to interpolation in the physical dimensions. This highlights the semantic meaningfulness of the discovered latent space.

In light of the above, it can be seen that the use of the encoder provides an effective means of acquiring and compressing a broad range of diverse behaviors into a suitable representation that makes them more effective when training a neural network. By conditioning the reward function used in reinforcement learning on the embeddings, the neural network is trained more effectively and efficiently to imitate a more diverse range of behaviors.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for training a neural network used to select actions to be performed by an agent interacting with an environment, the method comprising:
obtaining data identifying a set of trajectories, each trajectory comprising a set of observations characterizing a set of states of the environment and corresponding actions performed by another agent in response to the states;
obtaining data identifying an encoder that maps the observations onto embeddings for use in determining a set of imitation trajectories;
determining, for each trajectory, a corresponding embedding by applying the encoder to the trajectory;
determining a set of imitation trajectories by applying a policy defined by the neural network to the embedding for each trajectory; and
adjusting parameters of the neural network based on the set of trajectories, the set of imitation trajectories and the embeddings.

2. A method according to claim 1 wherein adjusting parameters of the neural network uses values output from a discriminator that have been conditioned using the embeddings.

3. A method according to claim 2 wherein adjusting the parameters of the neural network comprises determining a set of parameters that improves the return from a reward function, the reward function being based on a value output from the discriminator.

4. A method according to claim 3 wherein the reward function is:
rₜ^{j}(xₜ^{j}, aₜ^{j}|zⱼ)=−log(1−D_{ψ}(xₜ^{j}, aₜ^{j}|zⱼ))
wherein:
rₜ^{j}(xₜ^{j}, aₜ^{j}|zₜ^{j}) is the t^{th} reward for the j^{th} trajectory τⱼ={x₁^{j}, a₁^{j}, . . . , x_{T}^{j}, a_{T}^{j}};
xₜ^{j} is the t^{th} state from a total of Tⱼ state action pairs for the j^{th} trajectory;
aₜ^{j} is the t^{th} action from a total of Tⱼ state action pairs for the j^{th} trajectory;
z^{j} is the embedding calculated by applying the encoder q to the j^{th} trajectory, z^{j}˜q(·|x_{1:T}_{ⱼ}^{j}); and
D_{ψ}is the output of the discriminator.

5. A method according to claim 2 further comprising updating a set of discriminator parameters based on the embeddings.

6. A method according to claim 5 wherein the method comprises iteratively:
updating the parameters of the neural network based on the discriminator;
updating the discriminator parameters based on the set of trajectories, the set of imitation trajectories and the embeddings; and
updating the embeddings and imitation trajectories using the updated neural network, until an end condition is met.

7. A method according to claim 5 wherein updating the set of discriminator parameters utilizes a gradient ascent method.

8. A method according to claim 5 wherein updating the set of discriminator parameters comprises implementing:
$${min}_{θ} {max}_{ψ} {{τ}_{i} \text{∼} {π}_{E}}_{} \{ {q ( z \vert {x}_{1 \text{:} {T}_{i}}^{i} )}_{} [ \frac{1}{{T}_{i}} {\sum }_{t = 1}^{{T}_{i}} log {D}_{ψ} ( {x}_{t}^{i} , {a}_{t}^{i} \vert z ) + {{π}_{θ}}_{} [ log ( 1 - {D}_{ψ} ( x , a \vert z ) ) ] ] \}$$
wherein:
D_{ψ} is the discriminator function;
ψ is the set of discriminator parameters;
π_{θ} is the policy of the neural network;
θ is the set of parameters for the neural network;
π_{Ε} represents the expert policy that generated the set of trajectories;
q is the encoder;
τᵢ is the i^{th} trajectory, τᵢ={x₁ⁱ, a₁ⁱ, . . . , x_{T}_{ᵢ}ⁱ, a_{T}_{ᵢ}ⁱ}, where xₙⁱ is the n^{th} state and aₙⁱ is the n^{th} action from a total of Tᵢ state action pairs; and
z an embedding.

9. A method according to claim 8 wherein updating the set of discriminator parameters utilizes a gradient ascent method with gradient:
$${∇}_{ψ} \{ \frac{1}{n} {\sum }_{j = 1}^{n} [ \frac{1}{{T}_{j}} {\sum }_{t = 1}^{{T}_{j}} log {D}_{ψ} ( {x}_{t}^{j} , {a}_{t}^{j} \vert {z}_{j} ) ] + [ \frac{1}{{\hat{T}}_{j}} {\sum }_{t = 1}^{{\hat{T}}_{j}} log ( 1 - {D}_{ψ} ( {\hat{x}}_{t}^{j} , {\hat{a}}_{t}^{j} \vert {z}_{j} ) ) ] \}$$
wherein:
D_{ψ} is the discriminator function;
ψ is the set of discriminator parameters;
θ is the set of parameters for the neural network;
each trajectory, τⱼ, of the set of trajectories is τⱼ={x₁^{j}, a₁^{j}, . . . , x_{T}_{ⱼ}^{j}, a_{T}_{ⱼ}^{j}}, where xₙ^{j} is the n^{th} state and aₙ^{j} is the n^{th} action from a total of Tⱼ state action pairs;
each imitation trajectory, \hat{τ}ⱼ, is \hat{τ}ⱼ={\hat{x}₁^{j}, â₁^{j}, . . . , \hat{x}_{\hat{T}}_{ⱼ}^{j}, â_{\hat{T}}_{ⱼ}^{j}}, where \hat{x}ₙ^{j} is the n^{th} imitation state and âₙ^{j} is the n^{th} imitation action from a total of \hat{T}ⱼ imitation state action pairs; and
zⱼ is the embedding of the trajectory τⱼ.

10. A method according to claim 1 wherein obtaining the encoder comprises training a variational auto encoder based on the set of trajectories, wherein the encoder forms part of the variational auto encoder.

11. A method according to claim 10 wherein the variational auto encoder further comprises a state decoder for decoding the embeddings to produce imitation states and an action decoder for decoding the embeddings to produce imitation actions.

12. A method according to claim 11 wherein the action decoder is a multilayer perceptron and/or wherein the state decoder is an autoregressive neural network.

13. A method according to claim 11 wherein the policy is based on the action decoder.

14. A method according to claim 13 wherein the policy π_{θ} is:
π_{θ}(·|x, z)= [symbol] (·|μ_{θ}(x, z), σ_{θ}(x, z)
wherein:
x is a state from the trajectory;
z is the embedding calculated by applying the encoder to the trajectory;
μ_{θ} is a mean output from the neural network;
μ_{α} is the mean of the output of the action decoder; and
σ_{θ} is a variance of output of the neural network.

15. A method according to claim 14 wherein weights of the action decoder are kept constant after the action decoder has been determined.

16. A method according to claim 15 wherein the encoder is a bi-directional long short term memory encoder.

17. A system for reinforcement learning, the system comprising:
the encoder of a trained variational autoencoder neural network, the encoder comprising a recurrent neural network to encode a probability distribution of the trajectories as an embedding vector defining parameters representing the probability distribution; wherein the reinforcement learning system is configured to:
determine a target embedding vector for a target trajectory by sampling from the probability distribution encoded for the target trajectory by the encoder; and
train a reinforcement learning neural network using reward values conditioned on the target embedding vector.

18. A system as claimed in claim 17 wherein the reinforcement learning neural network comprises a policy generator and a discriminator, wherein the reinforcement learning system is configured to:
select actions to be performed by an agent interacting with an environment using the policy generator, to imitate a state-action trajectory;
discriminate between the imitated state-action trajectory and a reference trajectory using the discriminator; and
update parameters of the policy generator using reward values conditioned on the target embedding vector.

19. A system as claimed in claim 17 wherein the decoder comprises an action decoder and a state decoder, and wherein the state decoder comprises an autoregressive neural network to learn state representations for the decoder.

20. A system comprising one or more computers and one or more storage devices storing instructions that when executed by the one or more computers cause the one or more computers to perform operations for training a neural network used to select actions to be performed by an agent interacting with an environment, the operations comprising:
obtaining data identifying a set of trajectories, each trajectory comprising a set of observations characterizing a set of states of the environment and corresponding actions performed by another agent in response to the states;
obtaining data identifying an encoder that maps the observations onto embeddings for use in determining a set of imitation trajectories;
determining, for each trajectory, a corresponding embedding by applying the encoder to the trajectory;
determining a set of imitation trajectories by applying a policy defined by the neural network to the embedding for each trajectory; and
adjusting parameters of the neural network based on the set of trajectories, the set of imitation trajectories and the embeddings.
